(19) United States
(12) Patent Application Publication
(10) Pub. No.: US 2022/0222601 A1
(43) Pub. Date: Jul. 14, 2022

(54) PROCESS FOR INCREASING THE EFFICIENCY OF THE SCIENTIFIC RESEARCH BUSINESS CYCLE

(71) Applicant: AIXXIA LLC, McLean, VA (US)

(72) Inventors: Michael GOLDBLATT, McLean, VA (US); Murray TAYLOR, McLean, VA (US); Teri SCHINDLER, McLean, VA (US); Michael BECKER, McLean, VA (US); Flint DILLE, McLean, VA (US); Dan AREY, McLean, VA (US)

(73) Assignee: AIXXIA LLC, McLean, VA (US)

(21) Appl. No.: 17/524,636

(22) Filed: Nov. 11, 2021

Related U.S. Application Data
(60) Provisional application No. 63/125,253, filed on Dec. 14, 2020.

(51) Int. Cl. G06Q 10/06

(52) U.S. Cl. CPC G06Q 10/06313; G06Q 10/063118

(57) ABSTRACT

The process of identifying suitable subjects for scientific investigation, drawing together collaborators to perform that research, securing funding for that research and initiating the research is accelerated by a process that brings together researchers and investigators who provide short statements of evidence relevant to the subject of evidence. As the collection is built, investigators and researchers may provide conjectures and projections as to what sort of research the collection suggests. That collection is made available to funding entities on a secure basis to form proposed research initiatives they are desirous of funding from which proposals a research proposal is selected to perform the research on the subject of interest. Signing of researchers and initiating the research completes a process that completes the cycle of research and development more quickly than current models.

### PRIORITY DATA AND INCORPORATION BY REFERENCE

This application claims benefit of priority to U.S. Provisional Patent Application No. 63/125,253 filed Dec. 14, 2020 the entire disclosure of U.S. Provisional Patent Application Ser. No. 63/125,253 is expressly incorporated herein-by-reference.

### BACKGROUND OF THE INVENTION

### Field of the Invention

The present invention relates to methods of improving and accelerating the typical Research and Development (“R&D” herein) cycle that runs from development of an idea or project concept, to solicitation of funders, to investment and initiation. By altering the course of this cycle, formation of research programs can be accelerated with much more attention to the goals and possibilities offered by that research, and enhancing the funding of that research.

R&D has changed dramatically in the last 70 years; it is no longer considered a singular process, but a process that demands a multi-disciplinary approach. The current ways of interacting are not designed to optimize for the current conditions and researchers are not good at that individually. The structured approach described below lowers the bar to a cooperative, more efficient research process and creates a much lower risk of assessment.

### Background of the Invention

This invention pertains to a new process for developing new concepts, ideas and inventions on an accelerated pathway. The pathway is referred to herein as “Polyplexus.” Polyplexus is a unique process designed to efficiently transform the information and ideas submitted by participants into research projects through a series of purposed-designed steps, some of which are unique to the Polyplexus process. Polyplexus is a process that can be implemented in a physical location such as a meeting room or a virtual location such as an online platform. All process elements that call for information exchange could utilize in person communication, written communication, text input into an online platform, recorded voice and sound files, or video files, alone or in combination.

The typical approach to improving the efficiency of scientific research is to focus on the research projects themselves, but researchers have no interest in being inefficient, so the opportunity for improvement via this approach is not obvious. However, a significant portion of a researcher's time is spent assimilating information and composing research plans, many of which are never executed due to a lack of funding. Polyplexus brings efficiency to R&D by improving the efficiency of the exploration and planning period that is part of every research project, even those that are never executed due to a failure to find a funding source.

The R&D business cycle is a multi-stage business process involving a research funder, who is typically a business or government, and a group of potential proposers, who are typically academics, scientists at not-for-profits, scientists within industry, and occasionally scientists at government laboratories. During the R&D business cycle the group of potential proposers self-selects into a smaller group of actual project proposers. Proposers present a formal research plan to the funder and then the funder selects an even smaller group from the proposers for a research award. Once a formal research contract or agreement is finalized the selected proposers become researchers working for the funder in a capacity defined by the research contract or agreement.

### SUMMARY OF THE INVENTION

The totality of the novel Polyplexus features comprises a process which is a device for the acceleration of the R&D business cycle. The Polyplexus process brings structured efficiency by improving information flow during the pre-proposal, proposal evaluation, and research agreement negotiation portions of the business cycle. This general process is outlined chronologically in Table 1 and described in greater detail below:

TABLE 1
Polyplexus process stages, relationship to IP, and unique Polyplexus features.

| | | | | Polyplexus | |
|---|---|---|---|---|---|
| R&D Stage | Participants | IP Environment | Limiting Factor | Solution | |
| Background | Public | Unrestricted | Communication | Evidence | Polyplexus |
| and | | | Latency | microPubs; | Process |
| Information | | | | Incubators; | |
| Collection | | | | Games | |
| Ideation | Public | Unrestricted | Communication | Conjecture | |
| | | | Latency | microPubs; | |
| | | | | Incubators; | |
| | | | | Games | |
| Funder's | Bilateral - | Unrestricted | Awareness | Solicitation | |
| Solicitation | Funder to | | Among | Central | |
| | Potential | | Potential | Repository | |
| | Proposers | | Proposers | | |
| Planning & | Proposers | Proprietary to | - | - | |
| Proposing | | Proposer | | | |
| Submission | Bilateral - | Proprietary to | Process Latency | Automation | |
| & Selection | Funder to | Proposers; | | | |
| | Proposers | Documented | | | |
| | | Disclosure to Funder | | | |
| Research | Bilateral - | Proprietary to | Process Latency | Automation | |
| Agreement | Funder to | Proposers; | | and Pre- | |
| Negotiation | Selected | Documented | | Qualification | |
| | Proposers | Disclosure to Funder | | | |
| Funded | Bilateral - | Rights Defined in | - | - | |
| Research | Funder to | Research | | | |
| Prolect(s) | Researchers | Agreement | | | |

The purpose of the Polyplexus process is to increase the efficiency and speed of the R&D business cycle by modifying key elements of the process. The novel modifications to each phase provided by the Polyplexus process are noted below. Each phase is discussed below. It is noted that the invention lies in the full process reflected by implementation of the processes as discussed. Alternatives and modifications may be effected without departing from the invention by alteration or modification of individual aspects of one or more of the phases of the Polyplexus Process.

### DETAILED DESCRIPTION OF THE INVENTION

### Background and Information Collection

The Background and Information Collection phase provides the factual scientific basis for all subsequent phases. Scientific knowledge is disseminated in technical papers, presentations, patents, and technology, but the amount of information that scientists and technical experts must comb through to maintain currency is unprecedented with the total number of scientific and technical papers doubling every 9 years. As noted in Table 1, the primary limiting factor in this stage is the latency in communication of outcomes from scientific and technical articles. The Polyplexus process reduces the communication latency in this portion of the R&D business cycle by enabling collaboration and efficient information sharing among participants using the Polyplexus Evidence data structure.

In the Polyplexus process the Evidence structure calls for a process participant to summarize an implicit or explicit conclusion drawn from a technical article, scientific article, or other citable reliable source in a concise form consisting of 100 to 300 characters. Multiple pieces of Evidence may be drawn from a single source. Evidence statements are substantially shorter and distinct from article abstracts, which are typically descriptions of the complete article. Individual Evidence statements are written as a single statement of perceived fact or describing an outcome derived from the source. This format of decomposing article results enables participants in the process to easily understand and mix knowledge across disciplines. Further, the Evidence structure includes a citation back to the source as a supporting element within the process. When the process is executed on an online platform, the additional feature of automation linking the evidence to an online repository or database containing the source article or long form abstract may be implemented.

Evidence creation is accomplished by the current process participants, or alternatively Evidence can be accumulated over time from multiple interactions, stored in a file or database, and then re-used. Evidence creation is combined with Evidence review by the individual participants to complete the communication cycle. The Polyplexus process includes a number of approaches to enable and stimulate Evidence review. Process participants may, on their own, review the Evidence created by others because it is freely shared. The Polyplexus process also has a number of ways that Evidence review is stimulated, in particular contests and games. Games may take the form of judged contests to provide the best Evidence on a particular topic, or voting-based competitions where the participants cast ballots to determine winners in a head-to-head competition or bracket-style tournament based upon a contest theme established by the judges. An example is a bracket-style tournament where participants nominated 64 scientific papers as being the most likely to result in a new industry in the year 2040. The first round consisted of 32 head to head votes to determine winners, the second 16, etc. Similar tournaments could be run using other voting approaches such as first past the post. The contests or games may be played for enjoyment or prizes. Game mechanics around Polyplexus Evidence may be simple or as complex as the contest judges and competitors involved desire. A more detailed discussion of the games that may be employed is set forth below.

Another approach to stimulation of Evidence review is through communication among participants. These conversations, referred to herein as Incubators, could be facilitated or unfacilitated, although the facilitated conversation where one person or a few persons act as conversation leads is preferred. In Polyplexus Incubators the participants, optionally led by a facilitator, use Evidence that they have authored or discovered as foundations to support discussion points. As with all other parts of the Polyplexus process, these discussions could happen in-person at a physical location or in an online platform. In the facilitated embodiment the facilitator can guide conversation by setting discussion topics or asking provocative questions such as “Can we use this Evidence to reduce the cost of a product?”

### Ideation

The Ideation phase is where extensions are made to current knowledge to explore where a certain area of science and technology might go next. As noted in Table 1, the primary limiting factor on Ideation efficiency is communication latency.

In the Polyplexus online conversation and ideation system the Conjecture feature allows a conversation participant to specify two pieces of Evidence that can be newly created or selected from a database or file and then supply a concise supposition about how these two pieces of Evidence might be related or what these two pieces of Evidence, in concert, might enable, imply, or reveal. The preferred approach is if Evidence A is true and Evidence B is true, can the Conjecture be true? This approach promotes creative and critical thought supported by a rigorous foundation of Evidence. A Conjecture statement is typically 100 to 300 characters in length. Further, the Conjecture data structure requires linking of the Conjecture statement to the two pieces of Evidence and if desired, linking of the Conjecture statement to a segment of dialog text as a supporting element to an Incubator conversation.

In the embodiment of the Polyplexus process deployed at a physical location, the “linking” could be a line drawn on a piece of paper between a card where the Conjecture is written to two other cards where the Evidence is written. In the online context “linking” could refer to a clickable hyperlink that exposes the underlying data when selected, or a graphical representation such as a drawn line or similar that implies a relationship between the entities at each end of the line.

Polyplexus Conjectures reduce the communication latency in the ideation phase by providing a compact representation of both an idea and the evidentiary foundation supporting the idea. The efficiency gain comes from preventing ideas without an evidentiary foundation from distracting the participants and wasting time.

As noted in Table 1, the Games and Incubators described in the Background and Information Collection section could be modified to include Conjectures to further support the Ideation stage of the process by stimulating Conjecture sharing without altering or departing from the invention disclosed herein.

### Funder's Solicitation

The Funder's Solicitation is a definitive document published by an entity interested in financially supporting researchers and describes the scope and approach to the research area of interest to that Funder. As noted in Table 1, the primary limiting factor on this stage is awareness among the population of people who might author a research proposal in response to the Solicitation. The Polyplexus process improves the awareness of the Solicitation by attracting attention and interactions from all of the process steps occurring prior to the Solicitation. Evidence creation, Evidence Contests, Incubators, Conjecture Creation, and Conjecture Contests all are unique elements of the Polyplexus process and serve to raise awareness of a Funder's desire to support research on a topic, in particular when the Funder sets the rules for a contest or facilitates an Incubator around their area of interest. In addition, the Polyplexus process calls for a Central Solicitation Repository, which could be a physical location or an online document repository, to make discovery of Solicitations fast and efficient.

### Planning and Proposing

Planning and Proposing is the phase where individual proposers work independently and privately to develop a detailed research proposal including technical approach and budget justification to address the area of interest described in the Funder's Solicitation. An optional part of the Polyplexus process that improves the efficiency of this phase is to provide search and discovery tools to enable proposal authors to discover existing Polyplexus Evidence, Conjectures, or Incubator discussions that could benefit their proposals.

### Submission and Selection

The Submission and Selection phase encompasses secure transmission of all proposals to the Funder as well as the competitive evaluation and selection of the winning proposal(s) by the Funder. In the Polyplexus embodiment at a physical location, this could be as simple as an exchange of paper proposal documents. In the online embodiment this would include electronic document transmission and storage features to protect the proposers' proprietary information that could be included in a proposal. Alternatively, the Planning and Proposing phase and the Submission and Selection phase can be combined into a serial process of many (at least 3) small preparation and submission steps to reduce the barrier to entry posed by the large amount of work and expense of a single all-encompassing research proposal preparation and submission. In this embodiment the proposers may respond to small information requests from the Funder and each small submission would be reviewed by the sponsor and feedback given. Example small information requests are short research plan abstract, key background information, technical approach, team qualifications, key facilities, statement of work, work breakdown structure, budget estimate, and detailed budget. Feedback could be written comments on the submission or something as simple as encouraging or discouraging continued participation based upon the submission. At the conclusion of the series of small research requests the proposers would submit a single, all-encompassing, final proposal that incorporates all of the information and feedback given to date. The advantage of breaking the process into many small increments is twofold. First, the Funder interacts much more consistently and effectively with the proposers as proposals are being developed, resulting in more relevant and better proposals. Second, at each stage the proposers may draw the conclusion that their approach is not viable and choose to not proceed, which saves a significant amount of their time and the large amount of review time devoted to full proposals. This process could be executed through mail or in-person submissions and feedback or through an online interface. This process will also conclude with the selection of the proposal(s) to be funded.

### Research Agreement Negotiation

The output of the Research Agreement Negotiation phase is a contract that defines the level of support from the Funder, the time commitment by the Researcher, intellectual property rights for Funder and Researcher, project duration, and other key business concerns that are mutually agreed upon by the Funder and Proposer(s). The preferred embodiment of this phase of the Polyplexus process is a set of pre-negotiated agreements at research suppliers such as universities and not-for-profit laboratories to effectively pre-qualify proposers and also automation to support rapid generation of candidate contracts within the scope of the Researcher's or Funder's contract options.

### Research Project Output

After the Research Agreement is signed the Polyplexus process is complete. It is at this point where the Funded Research Project phase begins where the Proposer transforms into the Research and the actual research project is executed. The Polyplexus process is designed to transform all of the information inputs, idea inputs, and discussions into a structured and executable research plan through a combination of collaborative and independent activities executed by the participants. The Polyplexus process ends when a research agreement or contract is completed between the Funder and Proposer. The actual execution of the Research Project is beyond the scope of the Polyplexus process.

### Particular Features

The process is adaptable to various disciplines and communities. In person or online conversation system mechanisms that allow participants to author chronologically displayed dialog boxes and attach Evidence elements, Conjecture elements, and comments from other users for the purpose of supporting discussion points with reasoning. An in person or online conversation system mechanism that allows participants to interact with Evidence and Conjecture in a contest structure such as voting on one more piece of Evidence or Conjecture to determine a winner in a tournament format or other competitive structure that includes a ranking process and one or more competitive rounds. An in person or online conversation and ideation system mechanism that allows users to see all of the uses of a single piece of Evidence or a single Conjecture within the Polyplexus process on a tabletop or in a compact user interface permits effective idea creation and development.

A structured and integrated communication process called an Incubator that transforms comments from individuals, comments and instructions from a facilitator, supporting evidence or references to scientific or technical work or results, ideas from individuals regarding how the relationship between two elements of supporting evidence might indicate a future business or scientific opportunity (Conjectures in our language) into a single, cohesive, fully integrated and interdisciplinary discussion that bridges evidence from the past to innovative ideas about the future.

File or database analysis tools that enable a variety of search and analytics on a file or database containing records of the following types: Evidence, Conjectures, Incubators, profiles of participants, supporting scientific or technical papers, and relevant links between these elements including authorship, viewing of particular record by a participant, metrics calculated from participant interactions, writing quality based upon analysis of participant discussion posts using text analysis processing such as natural language processing or similar approaches, Evidence impact, Conjecture impact, graph neighborhood analysis, and customized search capabilities based upon ranked lists derived from the unique combination of Polyplexus records. This combined set of tools based upon the unique set of Polyplexus file or database records transforms the wide variety of records generated by the process participants into ranked search results enabling tool operators to search for and identify participants with a level of technical expertise, communication, breadth of knowledge, breadth of interest, community involvement, etc., all of which are demonstrated in practice within the Polyplexus process and so are supported by real activity in an evidence-based discussion rather than simply claims of individuals as those skills would be in a document like a personal resume or online post. The impact of these tools is that they transform the professional search process from resume review and verification into the much more quantitative process of evaluation of actual activity in a professional interaction environment.

A file or database or graph database is provided containing Evidence, Conjectures, Discussion Comments, underlying references for Evidence, user participation record, users, and relationships between all file or database entries for the purpose of transforming the individual unique Polyplexus records into a viable data substrate for calculation of derived metrics on all types of records and efficient search. The database and process includes file organization or Software engine enabling user-specified database or graph database analytics such as the influence, quality, or frequency of specific Evidence, Conjectures, Discussion Comments, underlying Evidence reference, or user path, community, connectivity, centrality or similar approaches for the purpose of transforming the data substrate into operator-defined ranked lists of database records based upon individual and combined sets of metrics and derived metrics. A filing structure or interface enabling general database or graph database analytics over the Evidence, Conjectures, Discussion Comments, underlying Evidence reference, user, and relationships between all database entries can be provided for the purpose of identifying participants with a particular skill in creating Evidence or Conjectures. In the in-person embodiment this could embody a set of forms for structured calculations.

Database or graph database automated analytics that utilize natural language processing or similar textual analysis algorithms to identify new or reinforce known relationships between Evidence, Conjectures, Discussion Comments, underlying references for Evidence, user participation record, users, and relationship database entries to transform the data gathered from participants into a higher density linked graph that includes both explicit (participant provided) and implicit (derived from automated analytics) relationships between Evidence, Conjectures, and all other records. The nature of the database lends itself to customizable search system utilizing the full connectivity of the database or graph database with user-selectable results filtering for one or more categories or by date range of results from Evidence, Conjectures, Discussion Comments, underlying references for Evidence, and users.

The Polyplexus process supports a variety of contest mechanisms utilizing the unique features of Evidence and Conjectures: best Conjecture on a particular topic, most Conjectures contest, Conjecture with the most diverse Evidence pair contest, Conjecture pairing a specified topic A with topic B contest, Conjecture that identifies a market opportunity contest, Conjecture that describes a product contest, Conjecture that will drive the miniaturization of a product or component contest, most interesting Conjecture contest, Conjecture with the widest gap between the dates of the two pieces of Evidence contest, Conjecture that will lead to a power reduction contest, best written Evidence contest, most surprising Evidence contest, best Conjecture connecting science Evidence to engineering Evidence, best Conjecture that makes some current product or component obsolete contest, best Conjecture that will cause and economic disruption contest, and variations thereof.

Game strategies can be varied, taking advantage of files, databases or graph databases containing Evidence, Conjectures, Discussion Comments, underlying references for Evidence, user participation record, users, and relationships between all database entries for the purpose of transforming the individual unique Polyplexus records into a viable data substrate for calculation of derived metrics on all types of records and efficient search. Importantly, a software engine enabling user-specified database or graph database analytics such as the influence, quality, or frequency of specific Evidence, Conjectures, Discussion Comments, underlying Evidence reference, or user using path, community, connectivity, centrality or similar approaches for the purpose of transforming the data substrate into operator defined ranked lists of database records based upon individual and combined sets of metrics and derived metrics is provided.

The interface enabling general database or graph database analytics over the Evidence, Conjectures, Discussion Comments, underlying Evidence reference, user, and relationships between all database entries for the purpose of identifying participants with a particular skill in creating Evidence or Conjectures. A database or graph database automated analytics that utilize natural language processing or similar textual analysis algorithms to identify new or reinforce known relationships between Evidence, Conjectures, Discussion Comments, underlying references for Evidence, user participation record, users, and relationship database entries to transform the data gathered from participants into a higher density linked graph that includes both explicit (participant provided) and implicit (derived from automated analytics) relationships between Evidence, Conjectures, and all other records. The customizable search system utilizing the full connectivity of the database or graph database with user-selectable results filtering for one or more categories or by date range of results from Evidence, Conjectures, Discussion Comments, underlying references for Evidence, and users is an important aspect of the system. A variety of contest mechanisms, both in-person and online, utilizing the unique features of Evidence and Conjectures: best Conjecture on a particular topic, most Conjectures contest, Conjecture with the most diverse Evidence pair contest, Conjecture pairing a specified topic A with topic B contest, Conjecture that identifies a market opportunity contest, Conjecture that describes a product contest, Conjecture that will drive the miniaturization of a product or component contest, most interesting Conjecture contest, Conjecture with the widest gap between the dates of the two pieces of Evidence contest, Conjecture that will lead to a power reduction contest, best written Evidence contest, most surprising Evidence contest, best Conjecture connecting science Evidence to engineering Evidence, best Conjecture that makes some current product or component obsolete contest, best Conjecture that will cause and economic disruption contest, and variations thereof.

### Example of Gaming Strategy

In one embodiment, Polyplexus is deployed as a gaming strategy. The “game” may result in identification of specific targets, or may be played purely for competition and enjoyment. Evidence Madness is a competition to identify seminal scientific evidence published within the last five years that will lead to new, transformative industries by 2040. More generically, evidence madness provides a framework to crowd source published evidence relevant to any hard scientific problems or literature review. In one example of an evidence madness competition participants are asked to identify published evidence that will create new industries by 2040. The game solicits 64 submissions from four domains—in this case Physics, Chemistry, Computer Science and the Life Sciences. Submitted evidence in each domain goes head-to-head in a competitive bracket competition until a winner is reached. The first, second and third place winners (the two lower scoring submissions to make it to the semifinals) may receive cash prizes or awards. Additional awards for predicting the most bracket winners as the competition advances are also made.

Game mechanics deploying Polyplexus may be simple or as complex as the competitors involved desire. A representative sample of rules and game conduct are provided herewith, but are not intended to be limiting. As one example, the game mechanics are broken out below into “Evidence Submission Rules, Voting Rules, and Rules to determine Winners (Winning Rules). Each is discussed in point-by-point detail, below.

### Evidence Submission Rules

In the gaming platform version of Polyplexus, the online platform receives submissions only from those eligible and registered, as is the case with sessions intended to generate scientific results immediately deployable. The Rules provide:

1. Participants must be registered on the Polyplexus platform in order to submit.

2. Participants create an Evidence μPub from a paper published in the last 5 years, with the DOI or preprint server link.

3. When submitting the evidence μpub the participant selects a domain from the menu, in this case: Physics (including solid state), Chemistry (including materials), Computer Science (software and hardware), and Life Sciences and then selects submit.

4. Participants then add a comment to their Evidence μPub that describes why the submitter feels the selected evidence is seminal and likely to lead to a new, transformative industry by 2040.

5. The Evidence μPub plus the comment officially qualifies the entry.

6. Submissions are evaluated based on first-come, first-considered basis and the quality of Evidence statement/justification comment.

7. If the submission is accepted, the submitter is eligible for the prize money.

8. One submission per participant; Each domain bracket will initially include 16 submissions, for a total of 64.

9. Bracket seeding will be randomly generated from the qualified submissions.

10. Submission period begins on, e.g., January 2 and ends on January 5.

11. Qualified Evidence μPub submissions in each domain bracket will appear simultaneously at the close of the submission period, filling out the brackets.

### Voting Rules

The gaming session continues, once the submissions have been made. Dates are arbitrary, and are fit to the time of year, and the size of the project or contest. Again, the following Rules are intended to illustrate the enhanced character of the game. Once the submissions have been made, voting ensues.

1. Voting begins when the Evidence Madness bracket is published on January 5.

2. Participants must be registered on the Polyplexus platform in order to vote.

3. First two rounds of voting are open for 3 days each, ending at midnight ET on the 3^{rd} day.

4. Next two rounds of voting are open for 2 days each, ending at midnight ET on the 2^{nd} day.

5. Final round of voting is open for 24 hours, ending at midnight ET.

6. One vote per matchup per participant in each round.

7. Voting should reflect the voter's opinion of the quality of the Evidence Statement, the quality of the justification, and the likelihood that this Evidence will foment a new, transformative industry by 2040.

8. Voters are encouraged to add additional comments and evidence to influence voting. All comments are public and are contained in the final transcript for publication.

9. In each matchup the Evidence μPub with the most votes advances to the next round.

10. Voting then begins for the next round.

### Winning Rules

As submissions increase, the targets grow increasingly complex. In this game example, the technology to be developed will grow in complexity and detail, as participants strive to outperform the other in subsequent rounds. This continues until the judges determine that the target progress has been made, and time has come to “call the game.” In similar fashion, in a non-gaming effort, once the participants have put together a sufficient body of evidence and understanding, those in charge of the game may close the platform to further submissions. In a game environment, winners may be selected according to the following exemplary process.

### Evidence μPubs

Evidence submissions increase throughout the game, until, as noted, the time has come to “call the game.” The evidence is advanced by the contestants in discreet form, referred to herein as Evidence μPublications or μPubs.

1. In the final round, the Evidence μPub with the most votes wins first place and $2040 for its submitter.

2. The Evidence μPub with second most votes wins second place and $1000 for its submitter.

3. Third and fourth semi-finalists both win $500 for their submitters.

### Individual Participants

While this invention resides in the cumulative Ideation Process and the enhanced results it produces with heightened efficiency and speed, the process and results are the results produced by the participants. While illustrated above in the context of a gaming strategy, whether in a game or a focused development of a particular strategy, the individual participants are critical. The inventor has found that when actually deployed, both in the context of a game as illustrated, and in an effort to promote ideation, individual participants participate for a variety of reasons. While a principal reason would be the obvious desire to be included in a funded research project, individuals identified participation in an intellectual conversation, scientific curiosity, personal desire to become an R&D influencer, and related desires such as the desire to meet like-minded interesting individuals and interact with them and otherwise contribute to development of new technology. Actual practice and feedback have demonstrated that money is not as powerful a motivator as these forces. In the game illustrated, typical individual recognition feeds the afore-mentioned desires, not monetary recovery.

1. The individual with the most winning selections across the full bracket of 64 wins $1000.

2. Second most winning selections wins $750.

3. Third most winning selections wins $500.

4. Fourth most winning pairs wins $250.

5. Fifth—10^{th} place wins $200.

6. Ties at any position divide the pot for that position.

7. Evidence Madness T-shirts will be awarded to all those whose submissions make up the brackets.

Not every use of Polyplexus and not every game need be complex. Weekly contests are smaller than Evidence Madness type games and are intended to be simpler, less demanding activities with small rewards. The goal of Weekly Contests is to drive interest in the Polyplexus platform with the chance of winning something like a T-shirt and to simultaneously motivate participants to explore and learn the basic mechanics of Polyplexus as an ideation platform. It is envisioned that these small contests will be run weekly or bi-weekly and large Evidence Madness style events will be held less frequently, perhaps quarterly. A panel of judges decides who the winners of the Weekly Contests are based upon the submission, the votes, and the discussion surrounding each entry.

Within the game, as opposed to formal ideation, rules and structure may be more flexible and adapted to goals in various ways. Nonetheless, even in the context of a gaming effort, general structure can be identified as discussed below in the context of Rules for

### Submission and Rules and Rules for Judging.

Evidence of Conjecture Submission Rules

In the context of a competitive game among individual participants, Polyplexus features consistent rules that reflect the advantages of the same system devoted more rigorously to ideation.

1. Participants must be registered on the Polyplexus platform in order to submit.

2. Participants create an Evidence or Conjecture μPub on a topic specified in the

Weekly Contest Incubator.

3. Participants then add a comment to their Evidence or Conjecture μPub that describes why the submitter feels the selected evidence is important to the topic specified in the Weekly Contest Incubator.

4. The Evidence μPub plus the comment officially qualifies the entry.

5. Submissions are evaluated for appropriateness relative to the topic based on first-come, first-considered basis and the quality of Evidence statement/justification comment.

6. If the submission is accepted, the submitter is eligible for the prize.

7. Three submissions per participant per Weekly Contest are allowed.

8. Weekly contests start on Monday and end on Friday.

9. Qualified μPub submissions appear in the Weekly Contest Incubator starting at the close of the day on Tuesday. The deadline to submit is close of the day on Wednesday.

10. Participants are free to vote and comment on each of the entries until close of the day on Thursday.

11. Judging commences at close of day on Thursday.

12. Winners are announced by close of the day on Friday.

### Judging Rules

Just as evidence submission from the participants in the game (or ideation process) is guided by rules agreed upon and provided to the participants by the platform manager, the evidence submissions are evaluated and “judged” by Rules established by the Polyplexus platform for the participants in advance.

1. The judging panel is made up of one or more experts in the topic under consideration in the Weekly Contest.

2. A judging rubric is posted Sunday evening or Monday morning of each Weekly Contest. The rubric describes the topic, goal, and process associated with each Weekly Contest.

3. Judges may use the submitted mPub, the submitter's justification statement, and any additional discussion to evaluate and rank the submissions.

4. The judging rubric will describe one of the following Contest types or similar: most economically valuable Evidence, Evidence that will positively impact the largest number of people, Evidence that will negatively impact the largest number of people, broadest impact basic science Evidence, most valuable pairs of Evidence, Evidence that leads to a reduction in power consumption, Evidence that broadens Polyplexus the most, Conjecture with the broadest potential economic impact, Conjecture with the most potential benefit to the scientific community, Conjecture with the most potential benefit to the poor, Conjecture that has the potential to make a current technology obsolete, Conjecture that implies something that will always be too expensive to be practical, Conjecture that potentially will save the most power, Conjecture that will change how science is done in the specialty represented by either or both of the supporting Evidence, best Conjecture that links two seemingly unrelated Evidence, or similar.

5. Contest winner is chosen by the judging panel using the rubric as a guide.

6. A prize or prizes are typically awarded to the winner and other highly ranked participants.

7. The judges' decision is final.

This invention has been described and disclosed in terms of both general discussion and by specific example. Variations of the invention as disclosed will occur to others without the exercise of inventive skill and remain within the scope of the invention, subject to the limitations of the claims advanced below. The critical aspects of the process of the invention that distinguish it from prior art attempts to generate and initiate research projects on a subject of evidence include the collection of short statements of evidence submitted by independent researchers that may spur other researchers to provide additional insights in a fashion that is not necessarily linear or predictable, and the ideation phase where, based on the collected information provided by independent researchers, projections of the “next logical step” for research into the given subject of interest are made and collected. These database collections coupled with the attribution to reliable sources of information allow for the development of projects for research that are selected and funded on a more rapid and complete basis.

What is claimed is:

1. A method of accelerating the development, funding and implementation of scientific research projects on a subject of interest, comprising:
A) Soliciting short statements describing scientific developments related to the subject of interest from a plurality of individuals familiar with aspects of the subject of interest, wherein said short statements identify the source of the information reflected in the short statement and collecting said short statements into a collection of information;
B) Reviewing said collection of information between all said individuals to assess and determine what new developments of said subject of interest might be made possible given the entire collection of information to identify potential projects that might provide valuable inventions,
C) Providing the information identifying potential projects to at least one entity interested in funding research into the subject of interest together with the collection of information,
D) Soliciting from at least one funding entity a research proposal that sets forth in detail the research to be undertaken, the cost of that research to be supported by said funding entity, the time frame for completing said research and the goal of said research,
E) Collecting all research proposals on said subject of interest and selecting at least one of said research proposals to be funded; and
F) Engaging qualified investigators to work on said at least one selected research proposal and thereby initiating said funded proposal as a research project.

2. The method of claim 1 wherein said steps of soliciting short statements and reviewing said collection is conducted in the presence of substantially all individuals interested in participating in the development of said scientific research project.

3. The method of claim 2, wherein substantially all individuals interested in participating in the development of said scientific research project are gathered together physically in one location for a period of time sufficient to provide said information identifying potential projects.

4. The method of claim 2 wherein substantially all said individuals interested in participating in the development of said scientific research project are provided access to said collection online and review said collection and identify said new developments by submitting same to an entity online.

5. The method of claim 1, wherein at least the quantity or quality of information identifying potential projects for funding is enhanced by engaging a plurality of individuals in a contest wherein said individuals submit short statements of evidence specific to a single project and wherein said statements of evidence are reviewed an evaluated by one or more judges as to value, with those individuals submitting statements of evidenced identified as having a relatively higher value by said judges being awarded prizes.

6. The method of claim 4, wherein said short statements of evidence are evaluated by said judges in a series of rounds of comparison between the value of said statements, each round commencing with submission of new statements of evidence based on the previously submitted short statements of evidence following evaluation of the prior round of statements.

7. The method of claim 1, wherein said qualified investigators are identified based at least on part by evaluation of said short statements describing scientific developments related to the subject of interest from a plurality of individuals familiar with aspects of the subject of interest, and engaging those offering the most highly evaluated statements in said research project.
